(19) United States
(12) Patent Application Publication
(10) Pub. No.: US 2026/0244696 A1
(43) Pub. Date: Aug. 20, 2026

(54) WORK SUPPORT SYSTEM, WORK SUPPORT METHOD, AND INFORMATION STORAGE MEDIUM

(71) Applicant: Cybozu, Inc., Tokyo (JP)

(72) Inventors: Yuta SAITO, Saitama-shi (JP); Tomoya IKEDA, Kawasaki-shi (JP); Kyosuke MIYAMURA, Sagamihara-shi (JP); Kohei SAITO, Tokyo (JP); Naoki TATEYAMA, Tokyo (JP)

(21) Appl. No.: 19/538,896

(22) Filed: Feb. 12, 2026

(30) Foreign Application Priority Data
Feb. 14, 2025 (JP) 2025-022201

(51) Int. Cl. G06F 16/9538; G06F 16/9535

(52) U.S. Cl. CPC G06F 16/9538; G06F 16/9535

(57) ABSTRACT

Provided is a work support system including at least one processor configured to: store a search setting, which relates to a search using retrieval-augmented generation (RAG), and is designated by a user who uses a work support service that supports work; retrieve, based on the search setting, from a work database that stores work data relating to the work, input work data which is the work data to be input to an artificial intelligence (AI) that supports the work; and support the work based on an output from the AI to which the input work data is input.

### CROSS-REFERENCE TO RELATED APPLICATION

The present disclosure contains subject matter related to that disclosed in Japanese Patent Application JP 2025-022201 filed in the Japan Patent Office on February 14, 2025, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, there has been known a technology referred to as retrieval-augmented generation (RAG) that combines a search function and artificial intelligence (AI). For example, in Japanese Patent No. 7588752, there is described an answer system which executes a search for words included in a request input by a user and a search for information relating to those words, inputs results of the searches into a large language model, which is an example of an AI, and outputs an answer from the large language model.

### SUMMARY OF THE INVENTION

However, with the technology of Japanese Patent No. 7588752, all of the data in the database serving as the parent population for the RAG search is searched, and hence there are cases in which inappropriate data which is unrelated to the request by the user is searched and input to the AI. This point is not limited to the technology of Japanese Patent No. 7588752, and can be said to apply to all related-art technologies relating to RAG. As a result, with the related-art technologies, it has not been possible to increase the accuracy of the output from the AI.

One object of the present disclosure is to increase the accuracy of an output from an AI. It is to be noted that the object of the present disclosure is not limited to that described in the "SUMMARY OF THE INVENTION" section.

According to at least one aspect of the present disclosure, there is provided a work support system including at least one processor configured to: store a search setting, which relates to a search using retrieval-augmented generation (RAG), and is designated by a user who uses a work support service that supports work; retrieve, based on the search setting, from a work database that stores work data relating to the work, input work data which is the work data to be input to an artificial intelligence (AI) that supports the work; and support the work based on an output from the AI to which the input work data is input.

### BRIEF DESCRIPTION OF THE DRAWINGS

FIG. 1 is a diagram for illustrating an example of a hardware configuration of a work support system.

FIG. 2 is a view for illustrating an example of screens displayed on a user terminal.

FIG. 3 is a view for illustrating an example of screens displayed on a user terminal.

FIG. 4 is a view for illustrating an example of screens displayed on a user terminal.

FIG. 5 is a view for illustrating an example of screens displayed on a user terminal.

FIG. 6 is a diagram for illustrating an example of functions implemented in the work support system.

FIG. 7 is a table for showing an example of a search setting database.

FIG. 8 is a diagram for illustrating an example of AI inputs and an AI output.

FIG. 9 is a table for showing an example of a work database.

FIG. 10 is a flowchart for illustrating an example of processing executed in the work support system.

FIG. 11 is a diagram for illustrating an example of functions implemented in a work support system according to modification examples.

FIG. 12 is a table for showing an example of a search setting database in Modification Example 1.

FIG. 13 is a view for illustrating an example of screens displayed on a user terminal in Modification Example 4.

FIG. 14 is a diagram for illustrating an example of a hardware configuration in Modification Example 4.

FIG. 15 is a diagram for illustrating an example of a flow of processing in Modification Example 5.

FIG. 16 is a table for showing an example of a search setting database in Modification Example 8.

FIG. 17 is a diagram for illustrating an example of AI inputs and an AI output in Modification Example 10.

### DETAILED DESCRIPTION OF THE INVENTION

### 1. Hardware Configuration

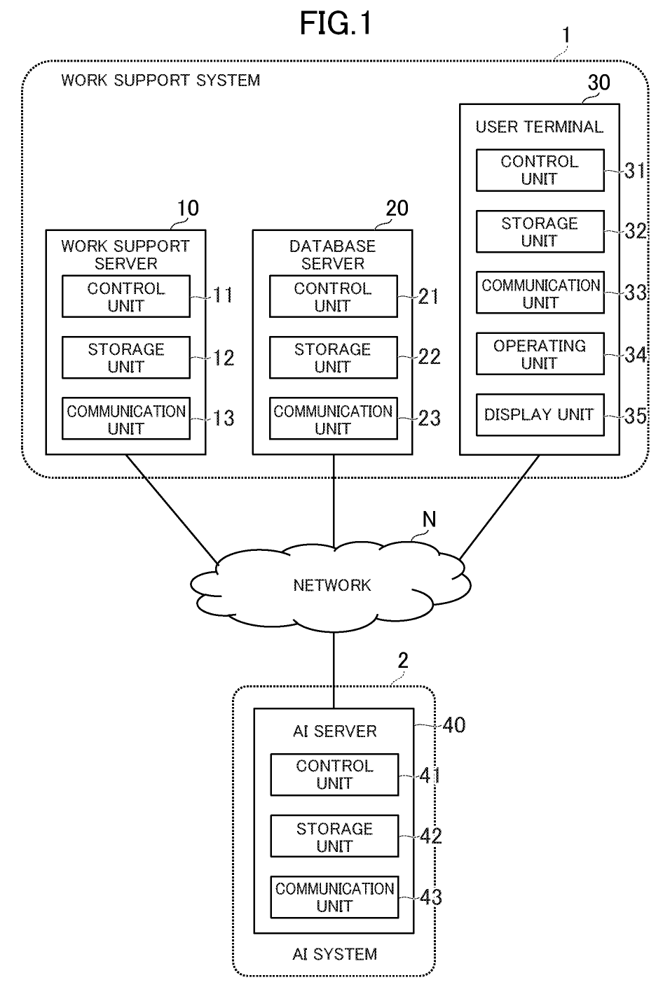

An example of a work support system, a work support method, and a program according to at least one embodiment of the present disclosure is described. FIG. 1 is a diagram for illustrating an example of a hardware configuration of the work support system. For example, a work support system 1 includes a work support server 10, a database server 20, and a user terminal 30. The work support server 10, the database server 20, and the user terminal 30 are each connected to a network N such as the Internet or a LAN.

The work support server 10 is a server computer of a work support service. The work support service is a service that supports work. A service called groupware is one example of the work support service. The work support service may be a service that is not called groupware in particular. In the at least one embodiment, a case in which the work support service is a cloud-based service is taken as an example, but the work support service may be of any type, and is not limited to a cloud-based service. The work support service may be an on-premises service. The work support server 10 may be a server computer of another service other than the work support service.

The work support server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The database server 20 is a server computer of the work support service. The database server 20 may also be a server computer of another service that works together with the work support service. For example, the database server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The user terminal 30 is a computer of a user. The user is a person or an organization that uses the work support service. The user is different from an operator which operates the work support service. The operator is a business that provides the work support service to users. For example, when an organization such as a company to which the user belongs contracts with the work support service (that is, when the organization is a tenant), the user is a person who belongs to the organization. The user can also be said to be a customer of the operator. The user may be an individual.

For example, the user terminal 30 is a personal computer, a tablet computer, a smartphone, or a wearable terminal. The user terminal 30 includes a control unit 31, a storage unit 32, a communication unit 33, an operating unit 34, and a display unit 35. Hardware configurations of the control unit 31, the storage unit 32, and the communication unit 33 may be the same as those of the control unit 11, the storage unit 12, and the communication unit 13, respectively. The operating unit 34 is an input device such as a mouse or a touch panel. The display unit 35 is a liquid crystal display or an organic EL display.

Programs stored in the storage units 12, 22, and 32 may be supplied through the network N. A hardware configuration of each of the work support server 10, the database server 20, and the user terminal 30 is not limited to the example of FIG. 1. For example, each of the work support server 10, the database server 20, and the user terminal 30 may include at least one of a reading unit (for example, a memory card slot) that reads a computer-readable information storage medium or an input/output unit (for example, a USB terminal) for directly connecting to an external device. A program stored in the information storage medium may be supplied to each of the work support server 10, the database server 20, and the user terminal 30 through at least one of the reading unit or the input/output unit.

Moreover, the work support system 1 is only required to include at least one computer. The computers included in the work support system 1 are not limited to the example of FIG. 1. For example, the work support system 1 may include only the work support server 10 and the database server 20. In this case, the user terminal 30 is present outside the work support system 1. The work support system 1 may include only the work support server 10. In this case, the database server 20 and the user terminal 30 are present outside the work support system 1. The work support system 1 may include only the user terminal 30. In this case, the work support server 10 and the database server 20 are present outside the work support system 1.

In the at least one embodiment, a case in which the work support system 1 can communicate to and from an artificial intelligence (AI) system 2 through the network N is taken as an example. For example, the AI system 2 includes an AI server 40. The AI server 40 is a server computer of an AI service. The AI service is a service that makes the AI available online. Details of the AI are described later. The AI server 40 includes a control unit 41, a storage unit 42, and a communication unit 43. Hardware configurations of the control unit 41, the storage unit 42, and the communication unit 43 may be the same as those of the control unit 11, the storage unit 12, and the communication unit 13, respectively. The AI system 2 is similar to the work support system 1 in that the hardware configuration of the AI system 2 is not limited to the example of FIG. 1.

### 2. Overview of Work Support System

In the at least one embodiment, a case in which an organization such as a company contracts with the work support service as a tenant is taken as an example. The user uses the work support service as a member of the tenant, which is the organization such as the company to which the user belongs. For example, the user uses the work support service from a browser installed on the user terminal 30. The user may use the work support service from a program dedicated to the work support service instead of a browser.

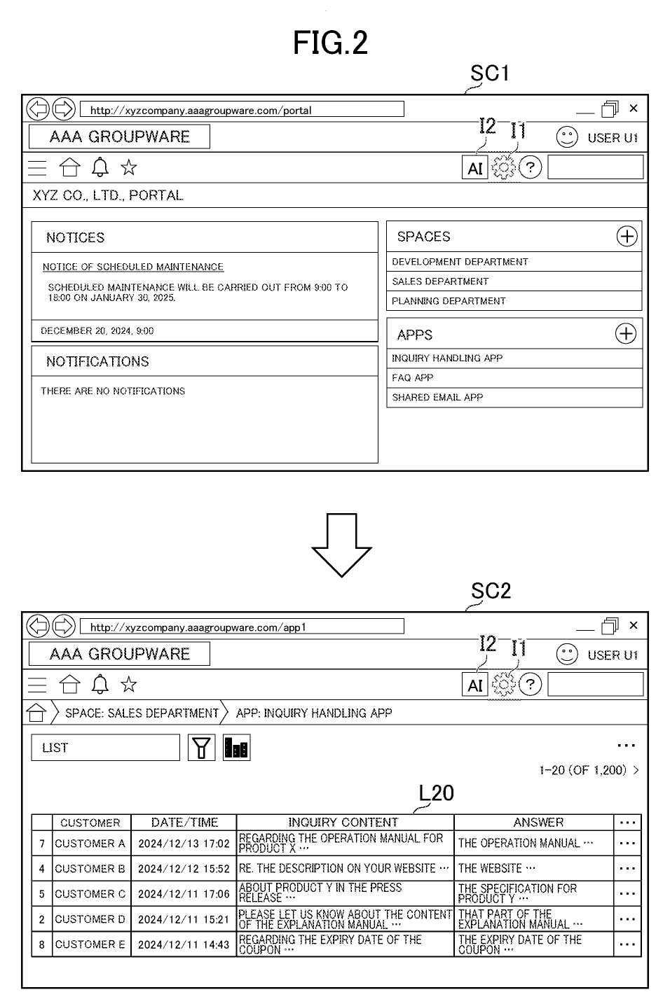

FIG. 2 to FIG. 5 are views for illustrating examples of screens displayed on the user terminal 30. For example, when the user logs in to the work support service, the user terminal 30 displays a portal screen SC1, which corresponds to an entrance to the work support service, on the display unit 35, as in the upper half of FIG. 2. The portal screen SC1 displays, for example, notices to all users belonging to the tenant, notifications for the user, icons for various settings, and information on work support functions that the user can use.

The work support function is a function that supports work. The work support function can also be said to be at least one of a program that indicates a series of information processing steps for supporting work or data to be referred to by the program. The work support function may be a function similar to that of a publicly-known work support service. For example, the work support function may be a data management function of managing data, a schedule function of managing schedules, a communication function of supporting communication between users, an email management function of managing emails, a workflow function of implementing a workflow, or another function.

In the at least one embodiment, the data management function is described as an example of the work support function. Further, a type of database called an app is described as an example of the data management function. The term "app" is generally an abbreviation for application, which is a type of program, but in the at least one embodiment, the app is a type of data management function. The app is a complex work support function that has not only the data management function but also another function such as the communication function. Various kinds of data relating to work are registered in the app. A user may communicate with another user by registering a comment in a record of the app.

For example, when the user selects an app from the portal screen SC1, the user terminal 30 displays, on the display unit 35, an app screen SC2 showing the app selected by the user, as in the lower half of FIG. 2. In the example of the lower half of FIG. 2, the app screen SC2 shows an inquiry handling app that stores information on inquiries from customers. The app screen SC2 includes a list L20 of records, which are units of data registered in the app.

For example, the first line of the list L20 displays field names, which are names of fields. A field is also called a column. The value of each field in each record is displayed in the second line onward of the list L20. When the user selects a record from the list L20, the user terminal 30 displays details of the record selected by the user on the app screen SC2. From the app screen SC2 showing the details of the records, the user can edit or delete an existing record or create a new record.

In the at least one embodiment, a case in which the user uses an AI assistant function as the work support function is taken as an example. The AI assistant function is a function in which the AI supports work. For example, the AI assistant function is implemented by the work support system 1 working together with the AI system 2. The AI assistant function is implemented by retrieval-augmented generation (RAG). There are various views in terms of definitions of RAG, but the RAG in the at least one embodiment may be RAG in any one of various publicly-known definitions. For example, the RAG may be a mechanism that searches information and generates an answer by using the search result.

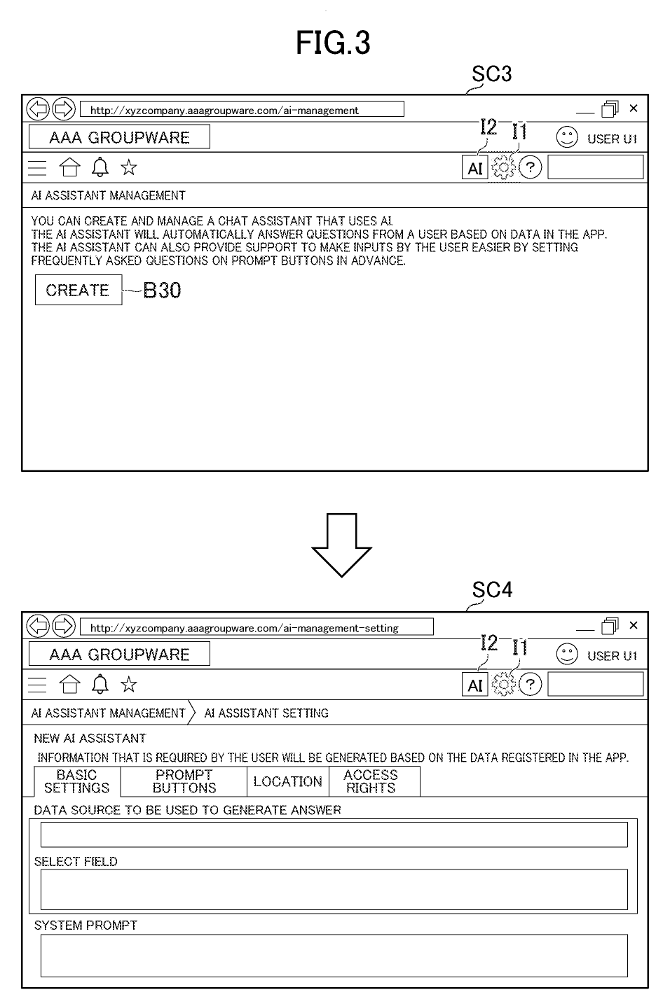

In the at least one embodiment, before starting to use the AI assistant function, the user designates a search setting relating to the RAG search. The search setting is a setting regarding the type of search to be performed by the RAG. For example, when the user selects an icon I1, the user terminal 30 displays, on the display unit 35, a list screen SC3 showing a list of AI assistant functions for which the search setting is designated, as in the upper half of FIG. 3. In the example of the upper half of FIG. 3, there is no AI assistant function for which the search setting is designated, and hence the name of an AI assistant function is not displayed on the list screen SC3. When the search setting for a certain AI assistant function is designated, the name of that AI assistant function is displayed on a setting screen SC4.

For example, when the user selects a button B30, the user terminal 30 displays, on the display unit 35, a setting screen SC4 for receiving designation of the search setting by the user, as in the lower half of FIG. 3. In the example of the lower half of FIG. 3, the search setting includes a plurality of setting items. In the at least one embodiment, of the plurality of setting items, the setting item of a data source to be used to generate an answer is mainly described. Details of the other setting items are described later in modification examples. The search setting may include only one setting item. The number of setting items included in the search setting may be any number.

The data source is the parent population of the data in the RAG search. The data source can also be said to be the data to be searched. For example, the user can designate an app as the data source. The user may designate a plurality of apps as the data source. The user may designate another data source other than an app. The user may designate a conversation thread or an online chat in a communication function as the data source. The user may designate emails in an email management function as the data source. The user may designate data managed by another work support function as the data source. The user may designate a combination of data managed by each of a plurality of work support functions, such as an app and conversation threading, as the data source.

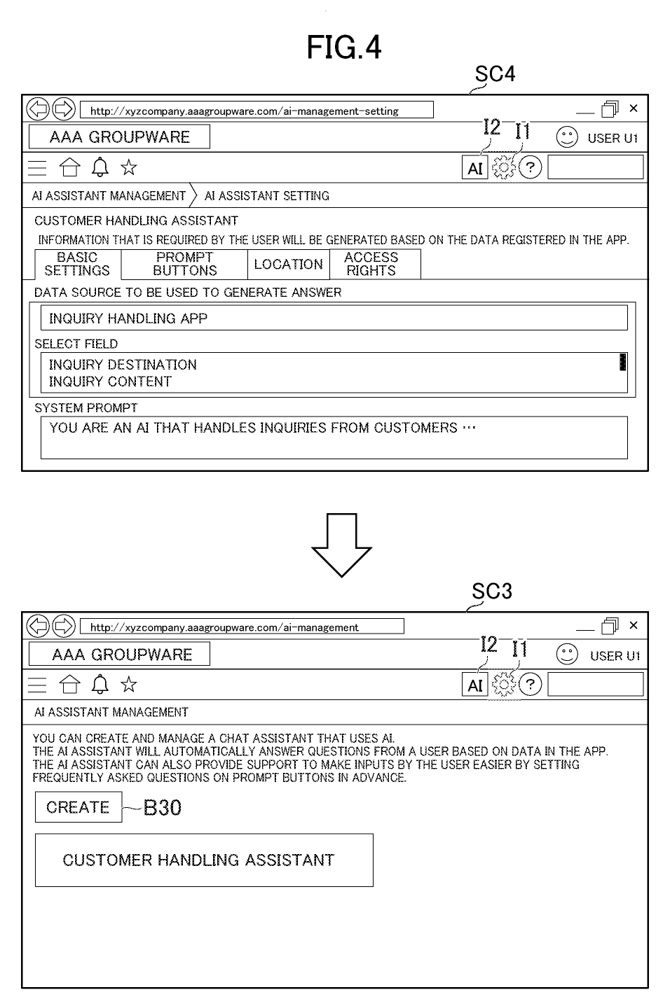

For example, when the user designates the search setting, the user terminal 30 displays, on the setting screen SC4, the search setting designated by the user, as in the upper half of FIG. 4. In the example of the upper half of FIG. 4, the user designates the inquiry handling app as the data source. The user may designate the name of the AI assistant function from the setting screen SC4. In the example of the upper half of FIG. 4, the name of the AI assistant function is "customer handling assistant." The user uses the AI assistant function in order to cause the AI to support customer handling work.

For example, when the user completes the designation of the search setting, the user terminal 30 displays, on the list screen SC3, the name of the AI assistant function for which the search setting is designated, as in the lower half of FIG. 4. In the example of the lower half of FIG. 4, "customer handling assistant" is displayed as the name of the AI assistant function. When the user selects an AI assistant function from the list screen SC3, the user can change the search setting of that AI assistant function. When adding a new AI assistant function, the user selects the button B30 and designates the search setting of the new AI assistant function.

For example, the user can call up the AI assistant function by selecting an icon I2. Another user (for example, a colleague at the same tenant) other than the user who designated the search setting of a certain AI assistant function may also be able to call up the AI assistant function. When there are a plurality of AI assistant functions, an icon I2 may be displayed for each AI assistant function, or a list of AI assistant functions may be displayed after the user selects the icon I2, and the user may select the AI assistant function from that list. Examples of the method of calling up the AI assistant function include using a mention in a post of a conversation thread (for example, a mention such as "@AI"), calling up in accordance with a schedule determined in advance, calling up mechanically by using an application programming interface (API) or a Webhook, or by another method.

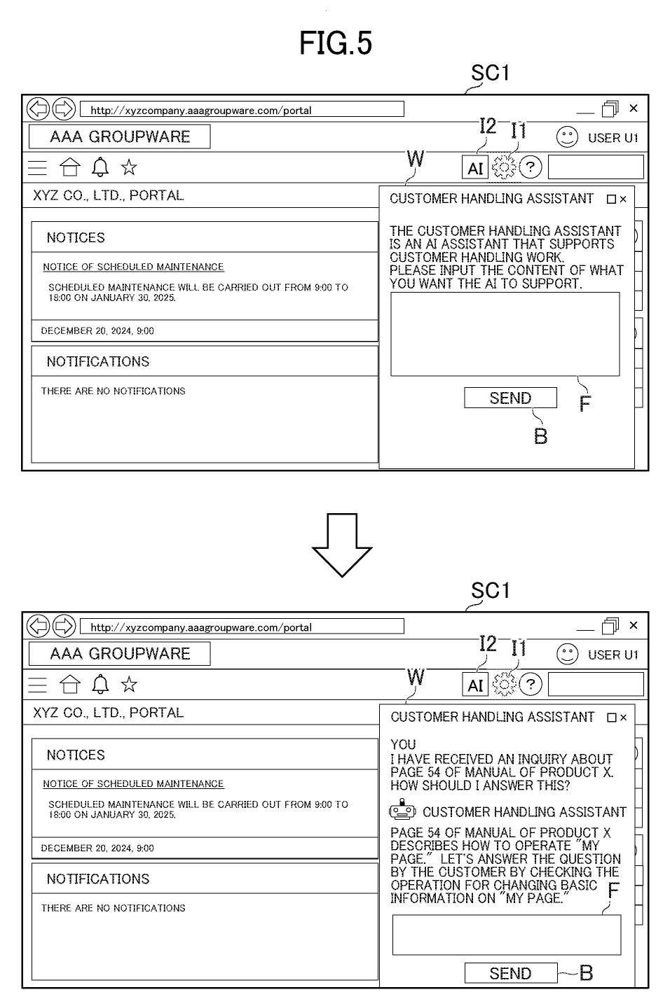

For example, when the user calls up the AI assistant function, the user terminal 30 displays a window W showing the AI assistant function on the display unit 35, as in the upper half of FIG. 5. In the example of the upper half of FIG. 5, the window W includes an input form F for receiving input of a user prompt, which is a prompt input by the user. When the user inputs the user prompt and selects a button B, a search is executed based on the search setting designated for the AI assistant function.

In the example of the upper half of FIG. 5, the customer handling app is designated as the data source, and hence the work support server 10 executes the RAG search based on the customer handling app. The work support server 10 does not execute the RAG search based on another app other than the customer handling app. The work support server 10 requests the AI server 40 to generate an answer by using the AI by transmitting the data acquired from the customer handling app together with the user prompt. When the AI server 40 receives the request from the work support server 10, the AI server 40 causes the AI to generate an answer. The work support server 10 transmits the output from the AI to the user terminal 30. The user terminal 30 displays the output from the AI in the window W, as in the lower half of FIG. 5.

As described above, with the work support system 1 according to the at least one embodiment, flexibility of the RAG search is increased by the user designating the search setting. For example, the user can designate the data source that is effective for supporting the work of the user, and hence the work support system 1 can prevent searching of data sources that are not required. As a result, the AI can generate an answer for work support based on a search result that uses the data source desired by the user as the parent population. As a result, the work support system 1 can increase the accuracy of the output from the AI. Details of the work support system 1 are now described.

### 3. Functions implemented in Work Support System

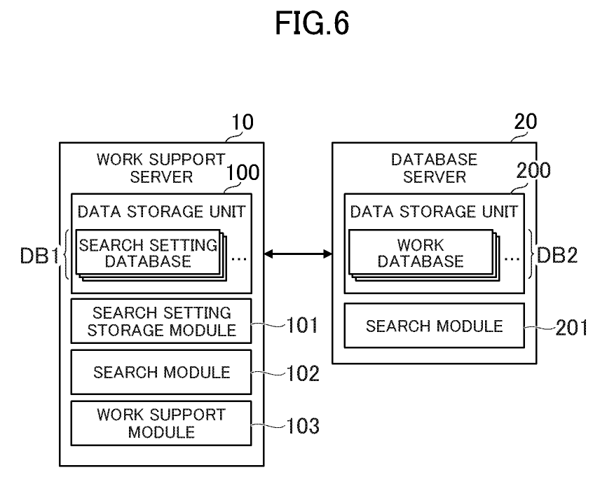

FIG. 6 is a diagram for illustrating an example of functions implemented in the work support system 1. In FIG. 6, functions implemented in the work support server 10 and the database server 20 among the functions implemented in the work support system 1 are illustrated.

### 3-1. Functions implemented in Work Support Server

For example, the work support server 10 includes a data storage unit 100, a search setting storage module 101, a search module 102, and a work support module 103. The data storage unit 100 is implemented by the storage unit 12. Each of the search setting storage module 101, the search module 102, and the work support module 103 is implemented by the control unit 11.

### Data Storage Unit

The data storage unit 100 stores various kinds of data in the work support service. In the at least one embodiment, a case in which the data storage unit 100 includes a storage area for each of a plurality of tenants (for example, organizations, non-organizational groups, or individuals) that use the work support service is taken as an example. That is, a case in which the storage area of the data storage unit 100 is divided into an area for each tenant is taken as an example. The storage area for a certain tenant stores the data of the certain tenant. The tenant can also be said to be a contractor of the work support service. For example, a search setting database DB1 containing the search settings designated by users of a certain tenant is stored in the storage area of that tenant.

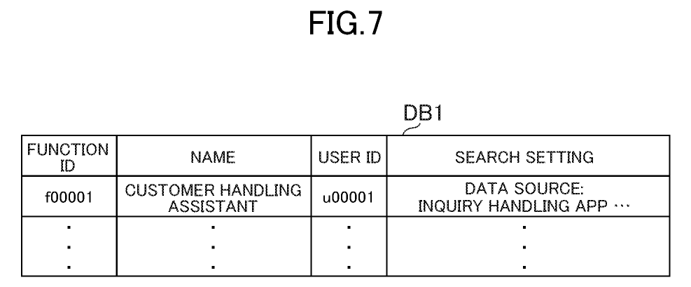

FIG. 7 is a table for showing an example of the search setting database DB1. For example, the search setting database DB1 stores a function ID that can be used to identify the AI assistant function, the name of the AI assistant function, a user ID that can be used to identify the user who designated the search setting, and the search setting. Any information may be stored in the search setting database DB1. The information stored in the search setting database DB1 is not limited to the example of FIG. 7. For example, a search setting history may be stored in the search setting database DB1.

For example, when a user of a certain tenant designates the search setting of a certain AI assistant function, the work support server 10 issues a function ID that does not overlap with other function IDs. The work support server 10 updates the search setting database DB1 stored in the storage area of the tenant so that the function ID and the name of the AI assistant function are associated with the search setting. When the user of the certain tenant changes the search setting of the certain AI assistant function, the work support server 10 updates the search setting database DB1 stored in the storage area of the tenant so that the search setting associated with the function ID and the name of the AI assistant function is changed.

A separate AI may be prepared for each AI assistant function, but in the at least one embodiment, a common AI is used for a plurality of AI assistant functions. That is, from the perspective of the user, the AI assistant functions are the functions that the user sees on the surface, and the AI behind the AI assistant functions is a single AI managed by the AI system 2. For this reason, the function ID and the name of the AI assistant function can also be said to be information that can be used to identify the search setting.

In addition, the storage area of the data storage unit 100 is not required to be divided into an area for each tenant. In this case, respective pieces of data of the plurality of tenants may be stored in the same storage area. The respective pieces of data of the plurality of tenants may be compiled in a common database stored in the data storage unit 100. For example, the data storage unit 100 may store a search setting database DB1 that is common to a plurality of tenants. A management method for the data of each tenant is not limited to the example of the at least one embodiment. The management method for the data of each tenant may be similar to that of a publicly-known work support service.

In addition, the data stored in the data storage unit 100 is not limited to the above-mentioned examples. The data storage unit 100 can store any data. For example, the data storage unit 100 may store data required for displaying each screen such as the portal screen SC1, the app screen SC2, the list screen SC3, and the setting screen SC4. The data storage unit 100 may store a database containing information for the users of each tenant to log in to the work support service.

### Search Setting Storage Module

The search setting storage module 101 stores a search setting, which relates to the RAG search, and is designated by a user who uses the work support service that supports work. The search setting is not designated by the operator of the work support service, but by a user different from the operator. For example, the search setting may be designated by a user who has a management authority at a certain tenant, or by a user who does not in particular have a management authority. A plurality of users at a certain tenant may have a management authority to designate the search setting.

The search setting may be any setting for the RAG search. For example, the search setting may be information that can be used to identify the work database DB2 itself, which is to be searched in the RAG, information that can be used to identify the database server 20 that stores the work database DB2 to be searched in the RAG, information that can be used to identify a part of the work database DB2 that is to be searched in the RAG, or other information. In the at least one embodiment, a case in which the search setting indicates the app to be searched in the RAG is taken as an example. The search setting may indicate another work database DB2 other than that of an app. The search setting may indicate a plurality of work databases DB2. Examples of other search settings are described later in the modification examples.

"Stores a search setting" means recording data indicating the search setting. In the at least one embodiment, a case in which the search setting storage module 101 stores the search setting in the data storage unit 100 is taken as an example. For example, the search setting storage module 101 stores the search setting in the search setting database DB1 of the data storage unit 100. The search setting storage module 101 may store the search setting in another place. For example, the search setting storage module 101 may store the search setting in another database other than the search setting database DB1, another computer other than the work support server 10 (for example, the database server 20), or an information storage medium.

For example, when a user of a certain tenant designates the search setting from the setting screen SC4, the user terminal 30 transmits the search setting to the work support server 10. When the work support server 10 receives the search setting, the search setting storage module 101 stores the search setting in the search setting database DB1 stored in the storage area of the tenant. Similarly, when a user of a certain tenant has changed the designated search setting, the search setting storage module 101 stores the changed search setting in the search setting database DB1 stored in the storage area of the tenant.

### Search Module

The search module 102 retrieves, based on the search setting, from a work database DB2 that stores work data relating to work, input work data which is the work data to be input to an AI that supports the work. The work database DB2 to be searched by the search module 102 is not limited to one work database DB2, and a plurality of work databases DB2 may be searched. The input work data is the work data to be input to the AI. The input work data includes at least one piece of work data retrieved in the search.

In the at least one embodiment, a case in which the search setting indicates the work database DB2 to be searched is taken as an example, and hence the search module 102 searches, among all the work databases DB2, the work database DB2 indicated by the search setting. Among all the work databases DB2, the search module 102 does not search another work database DB2 other than the work database DB2 indicated by the search setting. That is, the search module 102 sets the work database DB2 indicated by the search setting as the parent population of the search, and excludes the other work databases DB2 from the parent population of the search.

For example, the search module 102 acquires the user prompt from the user terminal 30 and searches the work database DB2 indicated by the search setting based on the user prompt. The search module 102 may use the user prompt as a search query directly, or may acquire a search query by morphologically analyzing the user prompt. The search module 102 may acquire a keyword from the search query, and use the acquired keyword as a search query, as in the modification examples described later.

The search based on the user prompt may be performed in a similar manner to a publicly-known RAG. The search module 102 may retrieve the work data that matches the user prompt from the work database DB2 based on a publicly-known search engine. The actual search processing may be executed by the search module 102 of the work support server 10, or by a search module 201 of the database server 20. The search module 102 may retrieve work data that matches the user prompt from the work database DB2 based on a machine learning model specialized for searching. In a case in which the user has not input a specific user prompt, the search module 102 may execute the search based on a search query prepared in advance. In this case, the search query prepared in advance corresponds to the search setting.

In the at least one embodiment, a case in which the database server 20 stores the work database DB2 is taken as an example, and hence the search module 102 requests the database server 20 to execute the search based on the work database DB2 indicated by the search setting. It is assumed that the request includes a search query, but the search query may also be acquired on the database server 20 side. For example, the request may include a user prompt, and the search query may also be acquired from the user prompt on the database server 20 side.

For example, the database server 20 executes the search based on the search module 201 described later, and transmits the execution result to the work support server 10. The search module 102 acquires the execution result of the search from the database server 20. When the work database DB2 is stored in the work support server 10, the search module 102 may search the work database DB2 stored in the work support server 10 without requesting a search from the database server 20.

### Work Support Module

The work support module 103 supports work based on the output from the AI to which the input data is input. The input data is data to be input to the AI. Input work data is an example of the input data. The input data may include content other than that indicated by the input work data. For example, the input data may include not only the content indicated by the input work data, but also at least one of a user prompt or a system prompt described later.

The output from the AI can also be said to be a calculation result calculated by the AI in accordance with the input data. The output from the AI can also be said to be the answer from the AI. In the at least one embodiment, a case in which the AI is managed by the AI system 2 is taken as an example, and hence the work support module 103 transmits input data to the AI system 2, and acquires the output from the AI from the AI system 2. When the work support system 1 manages the AI, the work support module 103 may acquire the output from the AI without communicating to and from the AI system 2.

"Supports work" means that the work support module 103 provides the output from the AI to the user terminal 30. In the at least one embodiment, the work support module 103 supports work by displaying the window W showing the output from the AI on the user terminal 30. That is, the work support module 103 supports work by transmitting data for displaying the window W to the user terminal 30. The work support module 103 may support work by displaying the output from the AI on the whole screen instead of in the window W. The work support module 103 may provide the output from the AI to the user terminal 30 by using another means such as email instead of displaying the output on a screen.

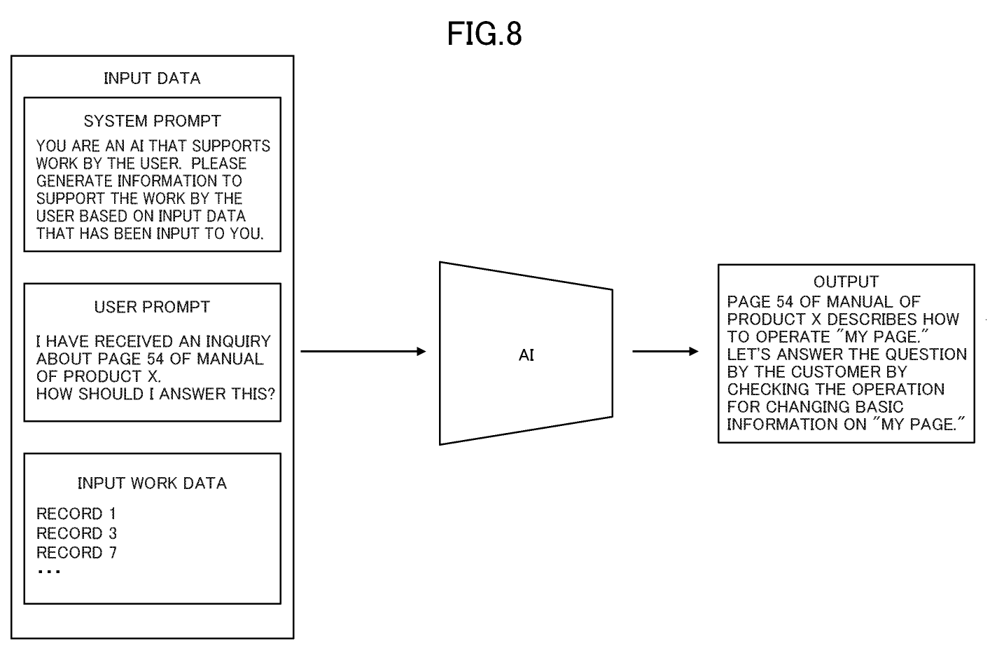

FIG. 8 is a diagram for illustrating an example of AI inputs and an AI output. The AI is a program capable of generating an electronic product based on input data that is information input to the AI. The AI may also be called a generative AI. There are various views in terms of definitions of the AI, but the AI in the at least one embodiment may be an AI in any one of various publicly-known definitions. The AI in the at least one embodiment includes various AIs recognized as AIs by a person skilled in the art at the time of filing. For example, the generative AI may not only be an AI developed by a machine learning method but also an AI developed by another method other than the machine learning.

For example, the AI may be a large language model, a machine learning model not classified as a large language model (a model trained by using a machine learning method, for example, a model such as generative adversarial networks (GAN) or variational autoencoders (VAE)), or another model. In the at least one embodiment, a case in which a pre-trained large language model corresponds to the AI is taken as an example. The large language model may be of any type. For example, the large language model may be a transformer-based model such as a generative pre-trained transformer (GPT) or bidirectional encoder representations from transformers (BERT), or another model not classified as a transformer (for example, a neural network).

For example, the AI includes a program that indicates a series of processes from when the input data is input until output is provided, and parameters to be referred to by the program. The parameters may be incorporated into a part of an AI program. The parameters of the AI may be similar to publicly-known parameters. For example, the parameters of the AI may be weights and biases. The AI may include other information other than the program and the parameters. The AI may be a single-modal type AI that can process only the input data in a specific format, or may be a multi-modal type AI that can process the input data in a plurality of formats.

For example, the AI may include an input layer that processes the input data, an intermediate layer that calculates an embedded representation of the input data based on the parameters, and an output layer that performs output corresponding to the embedded representation. The embedded representation is information for the AI to recognize the input data. The embedded representation may also be called a feature amount or a feature vector. The embedded representation may be a multidimensional vector, or may be in another form (for example, an array, a matrix, a single numerical value, or a plurality of numerical values). The input data may be divided into units called tokens. The AI may calculate embedded representations for individual tokens. The AI may predict the continuation of the input data based on a sequential order of the embedded representations of the individual tokens.

In the at least one embodiment, the AI is assumed to have already learned various kinds of training data. When a model capable of natural language processing, which is exemplified by the large language model, corresponds to the AI, the AI is assumed to have already learned various kinds of text for training as the training data. The parameters of the AI have been adjusted by learning the training data. A general-purpose AI that has been subjected to pre-training may be used as it is, or an AI that has been fine-tuned for the work support system 1 may be used. The learning method for the AI may be similar to a publicly-known machine learning method. As with the definitions of the AI, there are various views in terms of definitions of the machine learning, but the machine learning in the at least one embodiment includes various publicly-known definitions. For example, deep learning is also included in the machine learning.

In the at least one embodiment, a case in which the AI is managed by the AI system 2 is taken as an example, and hence the AI input can also be said to be information that is transmitted to the AI system 2 by the work support server 10. The AI output can also be said to be information that is received from the AI system 2 by the work support server 10. In the at least one embodiment, the AI output is information for supporting work. In the example of FIG. 8, a case in which the estimation result is text (a character string) in a natural language is taken as an example, but the estimation result may be in another format (for example, a single numerical value, a plurality of numerical values, an image, or program code) other than the text.

For example, a system prompt, which is a prompt prepared on the work support system 1 side, may be input to the AI. The prompt is an instruction to the AI. In the at least one embodiment, a case in which text written in a natural language corresponds to the prompt is taken as an example, but the prompt may also be text written in another language (for example, a programming language or a database language) other than the natural language. The prompt may also be in another format (for example, a document format, an image format, or a table format) other than the text.

In the at least one embodiment, the system prompt is assumed to be stored in the data storage unit 100. The system prompt may be stored in another computer other than the work support server 10 or an information storage medium. The work support module 103 may acquire the system prompt from the data storage unit 100, the another computer, or the information storage medium. A user prompt may be input to the AI. Both the user prompt and the system prompt may be input to the AI.

For example, the system prompt indicates processing content to be executed by the AI. In the at least one embodiment, a case in which a general-purpose AI that is not specialized for a specific task is used is taken as an example. Thus, the system prompt indicates a task of the AI. The task is content of processing to be executed by the AI. The system prompt may indicate specific content to be output by the AI. The system prompt may indicate what is to be input as the input data. The system prompt may indicate a role of the AI. In the at least one embodiment, a case in which the system prompt is prepared by an administrator of the work support service is taken as an example, but the system prompt may be prepared by the user.

In the example of FIG. 8, the system prompt indicates text such as "You are an AI that supports work by the user. Please generate information to support the work by the user based on input data that has been input to you." The system prompt may be any wording. The system prompt is not limited to the wording of FIG. 8. The work support module 103 inputs input data including the system prompt, the user prompt, and the input work data to the AI.

In the example of FIG. 8, the user prompt includes content relating to a specific page of the manual of a certain product. Accordingly, the search module 102 retrieves work data relating to the content, and acquires the retrieved work data as the input work data. For example, in the inquiry handling app, a record that includes content relating to the specific page corresponds to the input work data. The AI refers to the content of the record indicated by the input work data, and generates and outputs information for supporting the work (for example, content relating to the specific page of the manual).

In the at least one embodiment, the AI system 2 manages the AI, and hence the work support module 103 inputs the input data to the AI by transmitting the input data to the AI system 2. When the AI system 2 acquires the input data from the work support server 10, the AI system 2 inputs the input data to the AI stored in the AI system 2. When the actual data of the AI is stored in the data storage unit 100, the work support module 103 may input the input data to the AI stored in the data storage unit 100 without communicating to and from an external computer.

For example, the AI calculates an embedded representation of the input data that has been input to the AI based on parameters adjusted by pre-training. The AI may divide the input data into units called tokens, and calculate an embedded representation of each token. When the AI includes a plurality of intermediate layers, the AI may repeatedly calculate the embedded representation based on each individual intermediate layer. The AI generates and outputs an estimation result corresponding to the embedded representation. When the input data is divided into tokens, the AI generates and outputs an estimation result corresponding to a sequence of the embedded representations of the individual tokens. Internal processing of the AI is not limited to the example of the at least one embodiment. The internal processing of the AI may be processing similar to that of a publicly-known AI.

For example, the work support module 103 acquires the output from the AI. In the at least one embodiment, the AI system 2 manages the AI, and hence the AI system 2 transmits output from the AI to the work support server 10. The work support module 103 acquires an estimation result from the AI system 2. When actual data of the AI is stored in the data storage unit 100, the work support module 103 may acquire the output from the AI without communicating to and from an external computer.

The AI is not required to be a general-purpose AI specialized for a specific task, and may be an AI specialized for the task of supporting work. In this case, training data indicating a relationship between inputs and outputs for training is assumed to have been learned by the AI. The learning of the training data may be executed by the work support server 10, or may be executed by another computer. The AI is trained so that, when the input data and ground-truth outputs for training, which are indicated by the training data, are input to the AI, the estimation result for training, which is indicated by the training data, is output from the AI.

Further, the AI may be trained by a publicly-known learning method used in a machine learning method. For example, the training data may be learned by the AI by an error backpropagation method or a gradient descent method. When the AI is specialized for a specific task, the AI can generate an appropriate estimation result even without particularly having a prompt input thereto, and hence the work support module 103 may input the input data to the AI without inputting a prompt to the AI. In this way, a mode in which an estimation result is generated without the input of a prompt is also within the scope of the present disclosure.

### 3-2. Functions implemented in Database Server

For example, the database server 20 includes a data storage unit 200 and the search module 201. The data storage unit 200 is implemented by the storage unit 22. The search module 201 is implemented by the control unit 11.

### Data Storage Unit

The data storage unit 200 stores various kinds of data in the work support service. In the at least one embodiment, a case in which the data storage unit 200 has, like the data storage unit 100, a storage area for each of a plurality of tenants is taken as an example. For example, a work database DB2 which stores work data relating to work of a certain tenant is stored in the storage area of the tenant. The work database DB2 may be separate for each work support function, or may be shared by a plurality of work support functions.

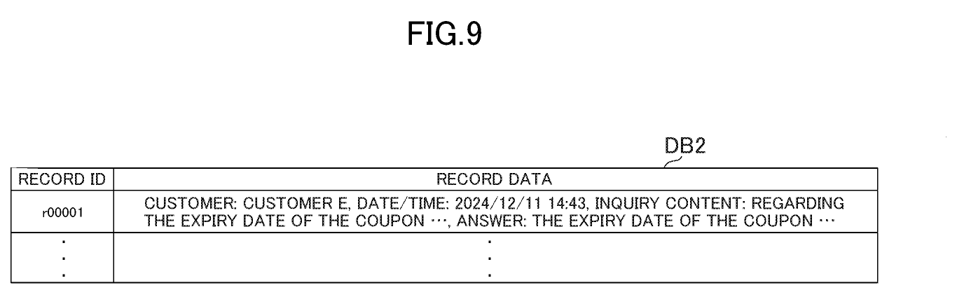

FIG. 9 is a table for showing an example of the work database DB2. In FIG. 9, an example of the work database DB2 for an app is shown. The work database DB2 may be a database for another work support function other than an app. For example, the work database DB2 stores individual records of the app. The records are examples of work data. The work database DB2 may also store other information. For example, the work database DB2 may store an index for searching individual records, an ID that can be used to uniquely identify the app, a name of the app, an app access right, an app setting, or other information.

For example, the work data indicates the names of fields in the app, the value of each field, a file uploaded to a portion other than a field, a comment registered in the record, and other information. When the user adds a record to the app, the record is added to the work database DB2 for that app. When the user updates a record in the app, the content of the record stored in the work database DB2 for that app is updated.

For work data of work support functions other than apps as well, the individual pieces of the work data are similarly stored in the work database DB2. For example, the work data for a schedule function indicates specific content of a schedule registered in the schedule function (for example, schedule date and time, participants, place, or a memo). The work data for a communication function indicates specific content of posts registered in a communication thread or an online chat (for example, a person posting, a comment, a name of the communication thread or online chat room in which the post is made, or date and time of posting). The work data for an email management function indicates the content of individual emails. Similarly, for other work support functions, the work data indicates the content of the work relating to those other work support functions.

Like the data storage unit 100, the storage area of the data storage unit 200 is not required to be divided into an area for each tenant. Further, the data stored in the data storage unit 200 is not limited to the above-mentioned examples. The data storage unit 200 can store any data. For example, the data storage unit 200 may store a search engine program.

### Search Module

The search module 201 searches the work database DB2 based on a search query acquired from the work support server 10. For example, the search module 201 may acquire the search setting from the work support server 10. When the data source is indicated in the search setting, the search module 201 identifies the work database DB2, or a part thereof, to be searched based on the data source indicated by the search setting. The search module 201 acquires, as the input work data, the work data corresponding to the search query from the identified search target based on a publicly-known search engine. The point that the search setting is applied is a novel configuration compared with the related-art technology, but the search processing after the search setting is applied may be the same as the search adopted in publicly-known RAG. The search module 201 transmits the input work data retrieved in the search to the work support server 10.

### 4. Processing executed in Work Support System

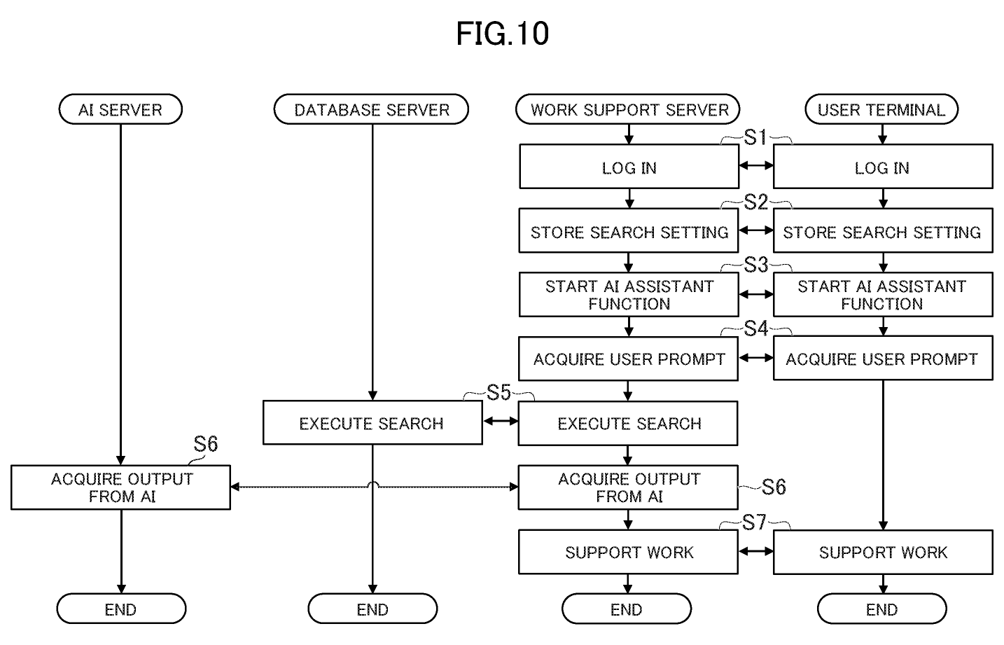

FIG. 10 is a flowchart for illustrating an example of processing executed in the work support system 1. Processing steps of FIG. 10 are executed by the control units 11, 21, 31, and 41 executing the programs stored in the storage units 12, 22, 32, and 42, respectively. The processing steps of FIG. 10 are an example of processing steps of the work support method according to the at least one embodiment. In FIG. 10, processing steps relating to the AI assistant function among the processing steps executed in the work support system 1 are illustrated.

As illustrated in FIG. 10, when the user designates the URL of the website of the work support service, the user terminal 30 executes, between the user terminal 30 and the work support server 10, processing for the user to log in to the work support service (Step S1). The work support server 10 executes, between the work support server 10 and the user terminal 30, processing for storing the search setting (Step S2). The processing step of Step S2 may be the same as the processing step described for the search setting storage module 101. The AI assistant function that has a function ID and a name associated with the search setting stored in the search setting database DB1 becomes selectable from the icon I2.

When the user designates the AI assistant function, the work support server 10 executes, between the work support server 10 and the user terminal 30, processing for starting the AI assistant function selected by the user (Step S3). In Step S3, the work support server 10 displays the window W showing the AI assistant function designated by the user on the user terminal 30. The work support server 10 executes, between the work support server 10 and the user terminal 30, processing for acquiring a user prompt (Step S4). In Step S4, the user terminal 30 transmits the user prompt input in the input form F to the work support server 10.

The work support server 10 executes, between the work support server 10 and the database server 20, a search based on the search setting (Step S5). The processing step of Step S5 may be the same as the processing step described for the search module 102. The work support server 10 executes, between the work support server 10 and the AI server 40, processing for acquiring an output from the AI based on the search setting (Step S6). The work support server 10 executes processing for supporting work based on the output from the AI acquired in Step S6 (Step S7), and the process ends. The processing steps of Step S6 and Step S7 may be the same as the processing steps described for the work support module 103. When the processing step of Step S7 is executed, the answer from the AI is displayed in the window W, as in the lower half of FIG. 5.

### 5. Summary of at Least One Embodiment

The work support system 1 according to the at least one embodiment stores the search setting, which relates to the RAG search, and is designated by the user who uses the work support service. The work support system 1 retrieves, based on the search setting, from the work database DB2 that stores the work data relating to the work, the input data to be input to the AI that supports the work. The work support system 1 supports the work based on the output from the AI to which the input data is input. As a result, the work support system 1 can execute the search in accordance with the search setting designated by the user, and hence can increase the accuracy of the output from the AI. For example, the user can designate the data source that is effective for the work support, and prevent searching of data sources that are not required. As a result, the AI can generate an answer for the work support based on a search result that uses the data source desired by the user as the parent population.

### 6. Modification Examples

The present disclosure is not limited to the at least one embodiment described above. The present disclosure can be modified as required without departing from the purport of the present disclosure.

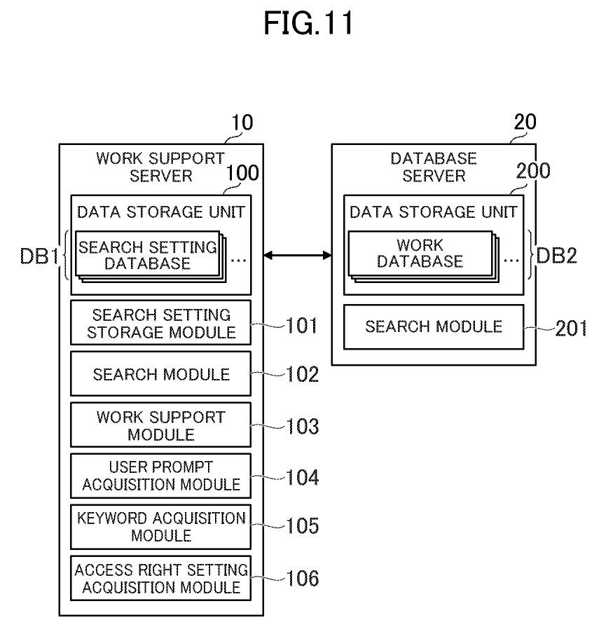

FIG. 11 is a diagram for illustrating an example of functions implemented in the work support system 1 according to the modification examples. As illustrated in FIG. 11, in the modification examples described below, the work support server 10 includes a user prompt acquisition module 104, a keyword acquisition module 105, and an access right setting acquisition module 106. Each of the user prompt acquisition module 104, the keyword acquisition module 105, and the access right setting acquisition module 106 is implemented by the control unit 11.

### 6-1. Modification Example 1

For example, as described somewhat in the at least one embodiment, a user may designate a search setting for each AI assistant function. The same user may designate search settings for a plurality of AI assistant functions, or a plurality of users may designate respective search settings for different AI assistant functions. That is, the user who designates the search setting for a certain AI assistant function may be different from the user who designates the search setting for another AI assistant function. The flow in which a user designates each search setting may be the same as in the at least one embodiment.

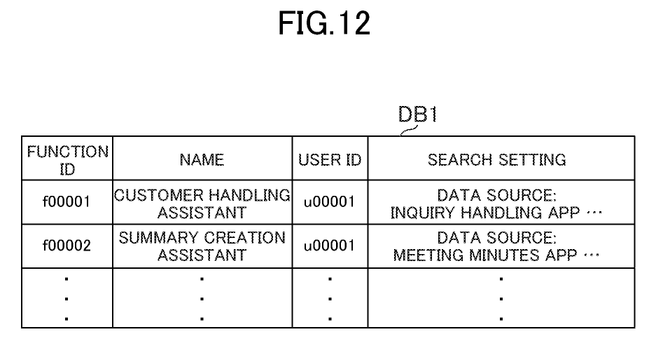

FIG. 12 is a table for showing an example of the search setting database DB1 in Modification Example 1. The search setting storage module 101 in Modification Example 1 stores a plurality of search settings. For example, the search setting storage module 101 stores the search setting of each of a plurality of AI assistant functions in the search setting database DB1. When a user designates the search setting of a certain AI assistant function, the user terminal 30 of the user transmits the designated search setting to the work support server 10. The work support server 10 receives the search setting from the user terminal 30. The search setting storage module 101 stores the function ID, for example, of the AI assistant function in the search setting database DB1 in association with the search setting.

In the example of FIG. 12, the search setting of a customer handling assistant and the search setting of a summary creation assistant are stored in the search setting database DB1. In Modification Example 1, it is assumed that the search setting of the customer handling assistant is the same as in the at least one embodiment. It is assumed that in the search setting of the summary creation assistant, a meeting minutes app in which the minutes of meetings are stored is designated as the data source. The search setting storage module 101 can store any number of search settings. The number of search settings stored in the search setting storage module 101 is not limited to two. The search setting storage module 101 may store three or more search settings.

The search module 102 in Modification Example 1 retrieves the input work data based on, among the plurality of search settings, the search setting selected by the user or another user who is using the AI. As used herein, the term "user" refers to the user who designates the search setting, and the term "another user" refers to a user other than the user who designates the search setting. The another user may or may not belong to the same tenant as that of the user. For example, instead of belonging to the same tenant as that of the user, the another user may be a member of an organization that cooperates with the tenant of the user.

For example, the search module 102 acquires, from the search setting database DB1, the search setting associated with the function ID of the AI assistant function selected by the user or another user among the plurality of AI assistant functions. The search module 102 retrieves the input work data based on the acquired search setting. Modification Example 1 differs from the at least one embodiment in that the required search setting is used in the search from among a plurality of search settings, but the flow in which the search module 102 executes the search based on the search setting may be the same as in the at least one embodiment. The processing of the work support module 103 after the search module 102 retrieves the input work data may also be the same as in the at least one embodiment.

The work support system 1 according to Modification Example 1 stores a plurality of search settings. The work support system 1 retrieves the input work data based on the search setting selected by the user or another user who is using the AI among the plurality of search settings. As a result, the work support system 1 can retrieve the input work data based on the search setting appropriate for supporting the work of the user or the another user, and hence can increase convenience for the user or the another user. The work support system 1 can support the work of the user or the another user based on the output from the AI corresponding to the user or the another user.

### 6-2. Modification Example 2

For example, in the at least one embodiment and Modification Example 1, the app serving as the data source has been described as the setting item of the search setting. The setting item of the search setting is not limited to the app that serves as the data source. In Modification Example 2, an example of another setting item is described. It is only required that the search setting include at least one of the setting item described in the at least one embodiment and Modification Example 1 or the setting item described in Modification Example 2.

The search setting storage module 101 in Modification Example 2 stores, as the search setting, a search field setting relating to a field which relates to the work database DB2 and which is to be searched in the RAG. In Modification Example 2, the actual data of the app is described as an example of the work database DB2. The meaning of a "field" of the app is as described in the at least one embodiment. When the work database DB2 of another work support function other than an app is usable in the RAG search, the search field setting may be, of the work database DB2 of the another work support function, a setting relating to the field to be searched. The field may be identified based on any information used in a publicly-known database. For example, the field may be identified based on a code or a name that can be used to identify the field.

For example, the search field setting indicates at least one field to be searched among a plurality of fields. Only one field may be searched, or a plurality of fields may be searched. In the example of the setting screen SC4 of the lower half of FIG. 3 and the upper half of FIG. 4, the user selects a field of the app designated as the data source from the "select field" input form. The user terminal 30 transmits the search field setting indicating the field selected by the user to the work support server 10. When the work support server 10 receives the search field setting, the search setting storage module 101 stores the search field setting in the search setting database DB1.

The search module 102 in Modification Example 2 retrieves the input work data based on the search field setting. The search module 102 searches the field indicated by the search field setting among all the fields in the work database DB2. The search module 102 does not search another field other than the field indicated by the search field setting among all the fields in the work database DB2. That is, the search module 102 sets, of the work database DB2, the data of the field indicated by the search field setting as the parent population of the search, and excludes the data of other fields from the parent population of the search. The parent population of the search is different from that in the at least one embodiment, but the search processing itself may be the same as in the at least one embodiment. The processing of the work support module 103 after the search module 102 retrieves the input work data may also be the same as in the at least one embodiment.

The work support system 1 according to Modification Example 2stores, as the search setting, a search field setting relating to a field to be searched in the RAG. The work support system 1 retrieves the input work data based on the search field setting. As a result, the work support system 1 can execute the search in accordance with the search field setting designated by the user, and hence can increase the accuracy of the output from the AI. For example, the user can designate the field that is effective for the work support, and prevent searching of fields that are not required. As a result, the AI can generate an answer for the work support based on a search result that uses the field desired by the user as the parent population.

### 6-3. Modification Example 3

For example, the setting item of the search setting is not limited to the examples described in the at least one embodiment, Modification Example 1, and Modification Example 2. In Modification Example 3, another example of the setting item of the search setting is described. The search setting may include some or all of the setting items described in at the least one embodiment and Modification Example 1, the setting item described in Modification Example 2, and the setting item described in Modification Example 3.

The search setting storage module 101 in Modification Example 3 stores, as the search setting, a search content setting relating to content which relates to the work data and which is to be retrieved in the RAG. The content relating to the work data is the specific content indicated by the work data. For example, when each record of an app corresponds to work data, the content of each record (for example, field values, files registered in the record, comments registered in the record, or other content) corresponds to the content relating to the work data.

The content relating to the work data is only required to be content that corresponds to the work support function. For example, the content relating to the work data of the schedule function may be the content of a schedule (for example, date and time, participants, or a memo). The content relating to the work data of the communication function may be the content of a post (for example, text, attachments, a person posting, or date and time). Similarly, for the content relating to the work data of another work support function, the specific content managed by the another work support function may correspond to the content relating to the work data.

The search content setting is a condition for the work data to be retrieved. The search content setting may be any setting of content that the work data can have. The user may designate, as the search content setting, the content to be retrieved, or conversely, the content not to be retrieved. In Modification Example 3, an input form of the search content setting is displayed on the setting screen SC4. For example, the user designates the search content setting from the input form. The search content setting may be characters, numerals, symbols other than characters and numerals, an on/off of a checkbox, an on/off of a radio button, or a setting of another piece of content.

For example, when a record of an app corresponds to the work data, the user designates the values that each field can take as the search content setting. When the user wants to search only records having a check box field set to "on", the user designates having a check box field set to "on" as the search content setting. Similarly, for the search content setting of other work support functions such as the schedule function or the communication function, the user designates the content that the work data can take (for example, date and time or a keyword) as the search content setting. The user terminal 30 transmits the search content setting designated by the user to the work support server 10. When the work support server 10 receives the search content setting, the search setting storage module 101 stores the search content setting in the search setting database DB1.

The search module 102 in Modification Example 3 retrieves the input work data based on the search content setting. The search module 102 retrieves, of the work database DB2, the work data having content that satisfies the search content setting. The search module 102 does not retrieve work data that does not satisfy the search content setting from the work database DB2. That is, of the work database DB2, the search module 102 sets the work data having content that satisfies the search content setting as the parent population of the search, and excludes the work data having other content from the parent population of the search.

For example, when a record of an app corresponds to the work data, the search module 102 retrieves a record that satisfies the search content setting (for example, a record having a check box of a specific field checked) in the app to be searched. Similarly, for other work support functions such as the schedule function or the communication function, the search module 102 retrieves, of the work database DB2, the work data that satisfies the search content setting (for example, a schedule for a specific date and time or a post that includes a specific keyword). The parent population of the search is different from that in the at least one embodiment, but the search processing itself may be the same as in the at least one embodiment. The processing of the work support module 103 after the search module 102 retrieves the input work data may also be the same as in the at least one embodiment.

The work support system 1 according to Modification Example 3 stores, as the search setting, the search content setting relating to the content to be retrieved in the RAG. The work support system 1 retrieves the input work data based on the search content setting. As a result, the work support system 1 can execute the search in accordance with the search content setting designated by the user, and hence can increase the accuracy of the output from the AI. For example, the user can retrieve the work data that has content which is effective for the work support, and prevent retrieval of work data having content that is not required. As a result, the AI can generate an answer for the work support based on a search result that uses work data having the content desired by the user as the parent population.

### 6-4. Modification Example 4

For example, the search setting storage module 101 may be able to store the search setting so that the work database DB2 of a place other than a specific place in the work support service or the work database DB2 of a service other than the work support service is searched. The search module 102 may be able to search the work database DB2 of the place other than a specific place in the work support service or the work database DB2 of the service other than the work support service.

As described somewhat in the at least one embodiment, in Modification Example 4, a case in which the AI assistant function is used at a specific place in the work support service is taken as an example. As used herein, "place in the work support service" is an online place in which the work support service is provided. The place in the work support service can also be said to be a page (screen) or work support function in which the work support service is provided. When the work support service is provided on a browser, the URL of the work support service corresponds to the place in the work support service. When the work support service is provided by a dedicated application, a screen in the application corresponds to the place in the work support service. The place in the work support service may be the work support server 10, the database server 20, another computer, or a storage area in an information storage medium.

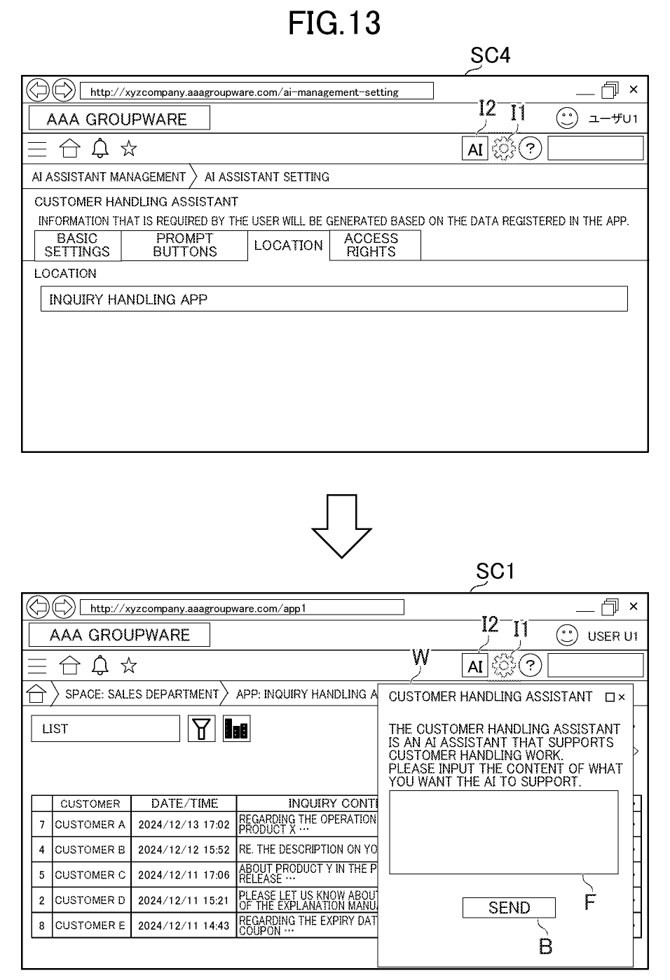

FIG. 13 is a view for illustrating an example of screens displayed on the user terminal 30 in Modification Example 4. For example, when the user selects a "location" tab on the setting screen SC4, the user terminal 30 can designate the place in which the AI assistant function for which the user is designating the search setting is to be used, as in the upper half of FIG. 13. In the example of the upper half of FIG. 13, the user designates an app as the place. The user may designate a plurality of apps as a plurality of places. When the work support service is provided on a browser, each app is provided with a separate URL, and hence when the user designates an app, the user is also designating a URL.

The user may designate a place other than an app. For example, the user may designate a work support function other than an app, such as the communication function, the email management function, or the schedule function. The user may designate external software as a service (SaaS) or an intranet system as the place other than an app. The user may designate a specific place in an individual work support function, such as a communication thread or an online chat room in the communication function. The user may also designate a place unrelated to a specific work support function, such as the portal screen SC1. When a user does not designate a specific place, the AI assistant function may be usable from any place.

In Modification Example 4, when the user designates the place, the search setting storage module 101 stores the search setting designated by the user and place identification information that can be used to identify the place designated by the user in the search setting database DB1 in association with each other. The place identification information may be any information that can be used to identify the place in the work support service in some way. For example, the place identification information may be a URL, an ID assigned to each screen, information that can be used to identify the work support function such as an app, or other information. The user or another user who is using a certain AI assistant function can use the AI assistant function from the place associated with the function ID and the name of the AI assistant function.

The work support module 103 in Modification Example 4 supports work at a specific place among a plurality of places in the work support service based on the output from the AI. The specific place is the place in which the AI assistant function is used. The specific place can also be said to be the place in which the AI assistant function is called up. The specific place can also be said to be the place in which the search corresponding to the search setting is to be executed. The work support module 103 does not support work based on the output from the AI in another place other than the specific place among the plurality of places. That is, the work support module 103 provides AI-based work support only in the specific place, and does not provide AI-based work support in other places.

In Modification Example 4, the specific place is a place for which place identification information is stored in the search setting database DB1. In the example of the lower half of FIG. 13, the inquiry handling app is designated as the specific place. For example, the work support module 103 refers to the search setting database DB1, identifies the specific place designated by the user, and supports, based on the output from the AI, the work of the user or another user who is using the place. In the example of the lower half of FIG. 13, the inquiry handling app is designated as the specific place, and hence the work support module 103 supports work in the inquiry handling app based on the output from the AI.

The place identification information indicating the specific place in which AI-based work support can be used may be stored in another database other than the search setting database DB1, another computer other than the work support server 10 (for example, database server 20), or an information storage medium. In this case, the search setting storage module 101 stores the place identification information in the another database, the another computer, or the information storage medium. The work support module 103 may identify the specific place based on the place identification information stored in the another database, the another computer, or the information storage medium, and when the use of the AI is requested from that specific place, support work based on the output from the AI.

The search setting storage module 101 in Modification Example 4 can store the search setting so that the work database DB2 of another place other than the specific place among a plurality of places is searched. That is, the work database DB2 that can be designated by the user as the data source is not limited to that of the specific place designated by the user. The user can designate the work database DB2 of another place as the data source. The user is not required to designate the work database DB2 of another place, and the user may freely decide whether or not to designate the work database DB2 of another place. When the user designates the work database DB2 of another place as the data source, the search setting storage module 101 stores a search setting that indicates the another place.

In the example of the upper half and lower half of FIG. 13, the specific place is the inquiry handling app. The user can designate another app other than the inquiry handling app as the data source. For example, when the user designates, as the data source, a frequently asked question (FAQ) app that stores various kinds of frequently asked questions, the search setting storage module 101 stores a search setting that indicates the FAQ app, which is another place, as the data source. When the user designates a plurality of other places, the search setting storage module 101 stores a search setting that indicates the plurality of other places as the data source. When the user designates the inquiry handling app, which is the specific place, the search setting storage module 101 stores a search setting that indicates the inquiry handling app, which is the specific place, as the data source.

The search module 102 in Modification Example 4 searches, when a search setting indicating that the work database DB2 of another place is to be searched is stored, the work database DB2 of the another place. For example, when another place is indicated in the search setting, the search module 102 executes the search by using the work database DB2 of the another place as the parent population of the search. Modification Example 4 differs from the at least one embodiment in the point that the work database DB2 of the another place becomes the parent population of the search, but the search processing itself may be the same as in the at least one embodiment. The processing of the work support module 103 after the search module 102 retrieves the input work data may also be the same as in the at least one embodiment.

In the above-mentioned example, a case in which the work database DB2 of another place in the work support service is searched has been described, but the work database DB2 of a place outside the work support service may be searched. In Modification Example 4, the work support service works together with an external service. The external service is another work support service different from the work support service provided by the work support system 1. In Modification Example 4, a case in which the operator operating the external service and the operator operating the work support service are different from each other is taken as an example, but those operators may be the same.

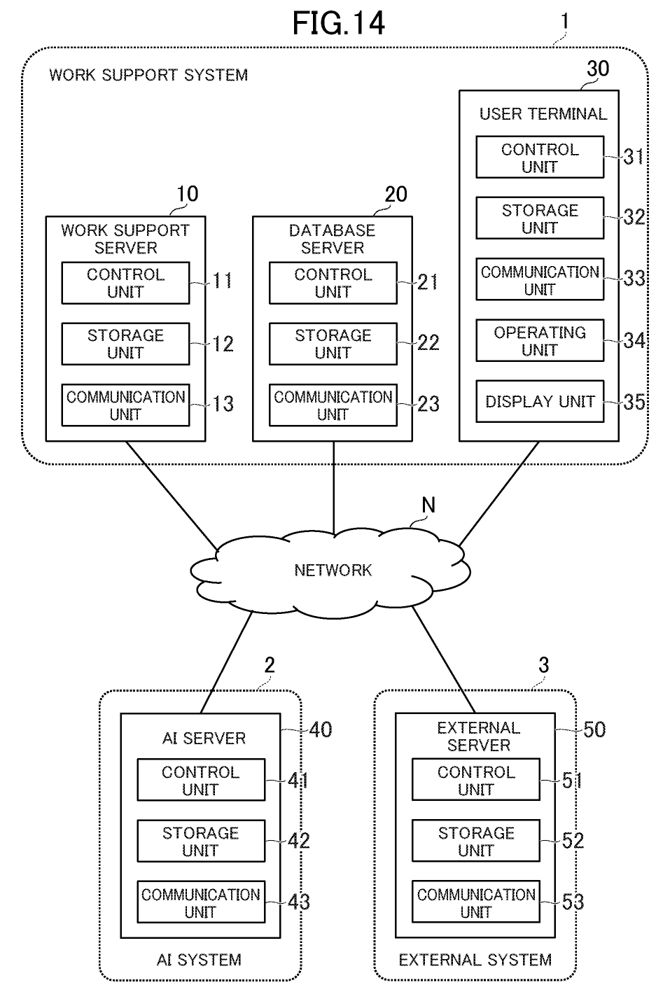

FIG. 14 is a diagram for illustrating an example of a hardware configuration in Modification Example 4. In Modification Example 4, a case in which the work support system 1 can communicate to and from an external system 3 through the network N is taken as an example. For example, the external system 3 includes an external server 50. The external server 50 is a server computer of an external service. The external server 50 includes a control unit 51, a storage unit 52, and a communication unit 53. Hardware configurations of the control unit 51, the storage unit 52, and the communication unit 53 may be the same as those of the control unit 11, the storage unit 12, and the communication unit 13, respectively. The external system 3 is similar to the work support system 1 in that the hardware configuration of the external system 3 is not limited to the example of FIG. 14.

For example, the tenant of the user also uses the external service. The external server 50 stores a work database DB2 in which work data of the external services is stored. The external service differs from the work support service in terms of the specific content of the service, but the work support functions and the meaning of the work data of the external service may be similar to those of the work support service. For example, the external server 50 provides a data management function, a schedule function, a communication function, an email management function, a workflow function, or other functions that are unique to the external service. The external server 50 stores a work database DB2 of those work support functions.

The search setting storage module 101 in Modification Example 4 can store the search setting so that the work database DB2 of the place outside the work support service is searched. The method of designating the data source may be the same as in the at least one embodiment and Modification Example 4. For example, the user designates the work database DB2 of the external service as the data source from the setting screen SC4. When there are a plurality of external services, the user may designate the work database DB2 of each of the plurality of external services. The search setting storage module 101 stores the search setting indicating the work database DB2 of the external service designated by the user as the data source.

The work support service and the external service work together with each other, and hence it is assumed that the work support server 10 can identify what type of work database DB2 is in the external service. The work support server 10 may identify what type of work database DB2 the tenant of the user is using in the external service, and display the name of the work database DB2 of the external service on the setting screen SC4. The user may designate the work database DB2 of the external service as the data source by designating that name.

The search module 102 in Modification Example 4 searches, when a search setting indicating that the place outside the work support service is to be searched is stored, the work database DB2 of the place outside the work support service. For example, when the work database DB2 of the external service is indicated in the search setting, the search module 102 executes the search by using the work database DB2 of the external service as the parent population of the search. Modification Example 4 differs from the at least one embodiment in the point that the work database DB2 of the external service becomes the parent population of the search, but the search processing itself may be the same as in the at least one embodiment.

For example, the external server 50 acquires, like the database server 20, the input work data by searching the work database DB2 stored in the external server 50 based on a request from the work support server 10. The external server 50 transmits the input work data to the work support server 10. The search module 102 acquires the input work data received by the work support server 10. When the work database DB2 in the work service is designated as the data source, the search module 102 executes a search in the same manner as in the at least one embodiment, and acquires the input work data. The processing of the work support module 103 after the search module 102 retrieves the input work data may also be the same as in the at least one embodiment.

The database server 20 may store a work database DB2 equivalent to the work database DB2 of the external service in the data storage unit 200 by synchronizing with the external server 50. In this case, the search module 102 may execute a search using the work database DB2 of the external service as the data source by requesting the database server 20 to perform the search, without transmitting a search request to the external server 50. That is, in the work support system 1, the search module 102 may execute a search using the work database DB2 of the external service as the data source, without communicating to and from the external server 50.

The work support system 1 according to Modification Example 4 can store the search setting so that the work database DB2 of a place other than a specific place in the work support service or the work database DB2 of a service other than the work support service is searched. The work support system 1 can search the work database DB2 of the place other than a specific place in the work support service or the work database DB2 of the service other than the work support service. As a result, the work support system 1 can retrieve the input work data that is effective for supporting work, and hence can increase the accuracy of the output from the AI. In the example of the upper half and lower half of FIG. 13, for a user or another user who is using the customer handling assistant for which the inquiry handling app is designated as a specific place, the work support system 1 can execute the search by also searching the FAQ app, which is another place, and provide the user or the another user with an output from the AI that corresponds to the input work data of the FAQ app. For example, the work support system 1 can use not only the work database DB2 in the work support service but also the work database DB2 of an external service as the data source, and hence can increase the accuracy of the output from the AI.

### 6-5. Modification Example 5

For example, in the at least one embodiment, a case in which the input work data is retrieved based on a user prompt has been described, but a keyword corresponding to a search query may be acquired based on the user prompt. In Modification Example 5, a case in which a keyword is acquired based on the user prompt and the input work data is retrieved based on the keyword is described.

The work support system 1 according to Modification Example 5 includes the user prompt acquisition module 104 and the keyword acquisition module 105. The user prompt acquisition module 104 acquires a user prompt input by the user or another user who is using the AI. For example, when the user inputs a user prompt in the input form F of the window W, as in the upper half of FIG. 5, the user terminal 30 transmits the user prompt to the work support server 10. The user prompt acquisition module 104 acquires the user prompt received by the work support server 10.

The keyword acquisition module 105 acquires a keyword for retrieving the input work data based on the user prompt. The keyword is a search query in the RAG search. The keyword acquisition module 105 can acquire the keyword from the user prompt by using a predetermined method. For example, the keyword acquisition module 105 may acquire the keyword from the user prompt based on an AI. In Modification Example 5, a case in which the AI for acquiring the keyword and the AI to which the input data is input are the same is described, but those AIs may be different from each other. That is, separate from the AI described in the at least one embodiment and Modification Examples 1 to 5, there may be an AI for acquiring the keyword.

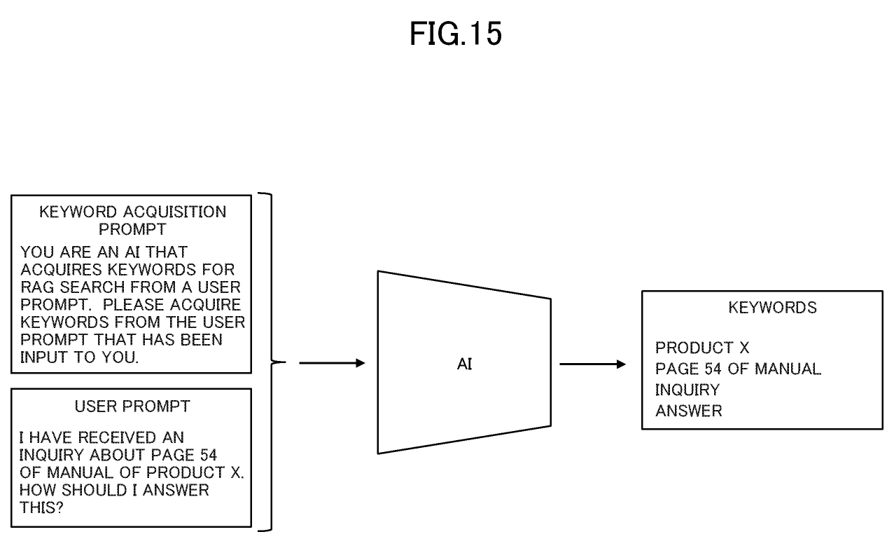

FIG. 15 is a diagram for illustrating an example of a flow of processing in Modification Example 5. For example, the keyword acquisition module 105 inputs a keyword acquisition prompt and the user prompt to the AI. The keyword acquisition prompt is a prompt determined in advance to acquire the keyword. The keyword acquisition prompt indicates that a keyword is to be acquired from the user prompt. When the AI is a large language model, the keyword acquisition prompt is written in a natural language. When the user prompt and the keyword acquisition prompt are input to the AI, the AI calculates an embedded representation of the input user prompt and keyword acquisition prompt, and outputs the keyword corresponding to the embedded representation. The keyword acquisition module 105 acquires the keyword output by the AI.

The keyword acquisition method is not limited to the above-mentioned example. For example, the keyword acquisition module 105 may acquire the keyword from the user prompt based on an AI specialized for keyword extraction instead of using a general-purpose large language model. In this case, it is assumed that the AI has learned training data indicating a relationship between user prompts for training and ground-truth keywords. The keyword acquisition module 105 inputs the user prompt to the trained AI and acquires the keyword output from the trained AI. The keyword acquisition module 105 may acquire the keyword by executing morphological analysis on the user prompt. In this case, the keyword acquisition module 105 may acquire a noun identified by the morphological analysis as the keyword.

The search module 102 in Modification Example 5 retrieves the input work data based on the search setting and the keyword. For example, the search module 102 searches the work database DB2 by using the keyword acquired by the keyword acquisition module 105 as a search query. Modification Example 5 is different from the at least one embodiment in the point that a keyword is used for the search, but the search processing itself may be the same as in the at least one embodiment. The processing of the work support module 103 after the search module 102 retrieves the input work data may also be the same as in the at least one embodiment. A fixed keyword may also be designated as the search setting.

The work support system 1 according to Modification Example 5 acquires a user prompt input by the user or another user who is using the AI. The work support system 1 acquires a keyword for retrieving the input work data based on the user prompt. The work support system 1 retrieves the input work data based on the search setting and the keyword. As a result, the work support system 1 can retrieve the input work data based on an appropriate keyword corresponding to the user prompt, and hence can increase the accuracy of retrieval of the input work data. As a result, the work support system 1 can increase the accuracy of the output from the AI.

### 6-6. Modification Example 6

For example, an appropriate search setting may differ depending on the user or another user who is using the AI. For example, when a person in the sales department of a certain tenant uses the customer handling assistant, it may be more appropriate for an app that is used mainly by sales department people to be the data source. When a person in the planning department of the certain tenant uses the customer handling assistant, it may be more appropriate for an app that is used mainly by planning department people to be the data source. Thus, in Modification Example 6, a case in which the input work data is retrieved based on an appropriate search setting corresponding to the user or another user who is using the AI is described.

The search setting storage module 101 in Modification Example 6 can store the search setting corresponding to the user or another user who is using the AI. For example, the user designates, on the setting screen SC4, user information on the user or another user who is using the AI. The user information may be user identification information that can be used to identify each user or other user, or user attribute identification information that can be used to identify attributes of each user or other user. The attributes can also be said to be classifications. For example, the attributes may be the department, job position, team, other group, age, age group, years of service, gender, or another attribute of the user.

In Modification Example 6, a case in which a department corresponds to user information is taken as an example. For example, the user designates the search setting of each of a plurality of departments on the setting screen SC4. That is, the user designates a search setting for each department. The search setting storage module 101 stores user information indicating the department designated by the user and the search setting of that department in the search setting database DB1 in association with each other. The user is not required to designate a search setting for all of the departments. The user may designate a search setting for a certain specific department and another search setting for the departments other than that department. Similarly, when the user information indicates another element other than a department, the search setting storage module 101 may store the user information indicating the another element and the search setting for the another element in the search setting database DB1 in association with each other.

The search module 102 in Modification Example 6 retrieves the input work data based on the search setting corresponding to the user or another user who is using the AI. For example, the search module 102 acquires the user information on the user or another user who is using the AI. The user information on the user or another user who is using the AI may be stored in advance in the data storage unit 100 or may be acquired from the user terminal 30. In Modification Example 6, the department corresponds to the user information, and hence the search module 102 acquires the user information from a user database that stores various types of information on the user or another user. Similarly, when the user information indicates another element other than the department, the search module 102 can acquire the user information from the user database. The search module 102 may acquire the user information from another database other than the user database, another computer other than the work support server 10, or an information storage medium.

For example, the search module 102 acquires the search setting associated with the user information on the user or another user who is using the AI from the search setting database DB1. The search module 102 retrieves the input work data based on the acquired search setting. For example, when the user information on the user or another user who is using the AI indicates the sales department, the search module 102 retrieves the input work data based on the search setting for the sales department. When the user information on the user or another user who is using the AI indicates the planning department, the search module 102 retrieves the input work data based on the search setting for the planning department. Modification Example 6 is different from the at least one embodiment in the point that that the search setting corresponding to the user or another user who is using the AI is used to execute the search, but the search processing itself may be the same as in the at least one embodiment. The processing of the work support module 103 after the search module 102 retrieves the input work data may also be the same as in the at least one embodiment.

The work support system 1 according to Modification Example 6 can store the search setting corresponding to the user or another user who is using the AI. The work support system 1 retrieves the input work data based on the search setting corresponding to the user or another user who is using the AI. As a result, the work support system 1 can retrieve the input work data corresponding to the user or another user who is using the AI, and hence can increase the accuracy of the output from the AI.

### 6-7. Modification Example 7

For example, there may be a work database DB2 that can be accessed by the user or another user who is using the AI, and a work database DB2 that is not to be accessed by the user or another user who is using the AI. In this case, when the input work data is acquired from the work database DB2 that is not to be accessed by the user or another user who is using the AI, the user or another user who is using the AI may become aware of information that originally such users are not to access. Thus, in Modification Example 7, a case in which the search is executed in accordance with an access right is taken as an example.

The work support system 1 according to Modification Example 7 includes the access right setting acquisition module 106. The access right setting acquisition module 106 acquires an access right setting relating to an access right of the work database DB2. In Modification Example 7, it is assumed that the access right setting is included in the work database DB2. For example, the access right setting acquisition module 106 acquires, from the database server 20, the access right setting of the work database DB2 to be searched. The access right setting may be stored in another database other than the work database DB2, another computer other than the database server 20 (for example, work support server 10), or an information storage medium. In this case, the access right setting acquisition module 106 may acquire the access right setting from the another database, the another computer, or the information storage medium.

The search module 102 in Modification Example 7 retrieves the input work data based on the search setting and the access right setting. For example, the search module 102 retrieves the input work data based on, among the work databases DB2 of the data sources indicated by the search setting, the work database DB2 for which the access right setting permits access by the user or another user who is using the AI. That is, the search module 102 identifies the work database DB2 that is actually to be used as the data source based on two conditions: that the search setting indicates that the work database DB2 is the data source, and that access by the user or another user who is using the AI is permitted. The search module 102 retrieves the input work data from the identified work database DB2. The method of identifying the work database DB2 that serves as the data source is different from that in the at least one embodiment, but the search processing itself may be the same as in the at least one embodiment. The processing of the work support module 103 after the search module 102 retrieves the input work data may also be the same as in the at least one embodiment.

The access right setting may indicate the access right for each piece of work data stored in the work database DB2 instead of the access right for the entire work database DB2. For example, when an app corresponds to the work database DB2, the access right setting may indicate the access right for each record of the app, or indicate the access right for a part (for example, a field) in each record. In this case, the search module 102 may execute the search by using the work data or a part of the work data that can be accessed by the user or another user who is using the AI as the data source.

The work support system 1 according to Modification Example 7 acquires an access right setting. The work support system 1 retrieves the input work data based on the search setting and the access right setting. As a result, the work support system 1 can execute the search in accordance with the access right of the user or another user who is using the AI, and hence can prevent the user or another user who is using the AI from becoming aware of information that originally such users are not to access.

### 6-8. Modification Example 8

For example, as described somewhat in the at least one embodiment, the AI assistant function may be associated with a plurality of user interface parts. The parts of the user interface are parts which receive user operations. The parts of the user interface may be any part, such as a button, an icon, a bar, text, or another part. The parts of the user interface may be displayed within the window W or in a place separate from the window W.

For example, in the case of the customer handling assistant, separate parts may be displayed, such as parts for the sales department and parts for the planning department. In this case, a search setting may be stored for each part. For example, when a part for the sales department is selected, the sales department app may become the data source, and when a part for the planning department is selected, the planning department app may become the data source. In Modification Example 8, a case in which a search setting is stored for each part is described.

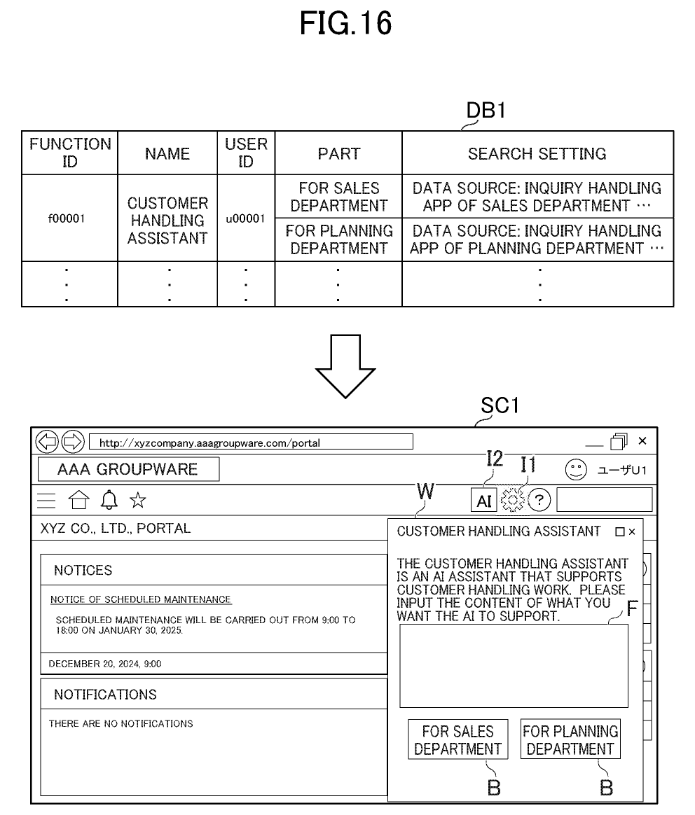

FIG. 16 is a table for showing an example of the search setting database DB1 in Modification Example 8. The search setting storage module 101 in Modification Example 8 can store each of a plurality of parts which receive an instruction in order for the user or another user to use the AI in association with the search setting. In Modification Example 8, the user can designate the search setting for each part from the setting screen SC4. In the example of the setting screen SC4 of the lower half of FIG. 3 and the upper half of FIG. 4, a prompt button is an example of a part. The prompt button is associated with a system prompt input by the user when the user designates the search setting. The system prompt is described in Modification Example 10 described later.

For example, the user terminal 30 transmits the search setting of each of the plurality of parts designated by the user on the setting screen SC4 to the work support server 10. The search setting storage module 101 stores the search setting of each of the plurality of parts received by the work support server 10 in the search setting database DB1. The search setting storage module 101 stores part identification information that can be used to identify a part and the search setting designated for that part in the search setting database DB1 in association with each other, as in the upper half of FIG. 16. In the example of the upper half of FIG. 16, the user designates a search setting for each part for the sales department and each part for the planning department. The part identification information may be any information such as an ID or a name assigned to the part on the screen.

The search module 102 in Modification Example 8 can retrieve the input work data based on the search setting associated with, among the plurality of parts, the part selected by the user or another user who is using the AI. In the example of the lower half of FIG. 16, a part for the sales department (for example, button B showing the text "for sales department") and a part for the planning department (for example, button B showing the text "for planning department") are displayed in the window W. The search module 102 acquires, from the search setting database DB1, the search setting associated with the part identification information on the part selected by the user or another user who is using the AI among those plurality of parts. Modification Example 8 differs from the at least one embodiment in the point that, among the search settings of the plurality of parts, the required search setting is used for the search, but the flow in which the search module 102 executes the search based on the search setting may be the same as in the at least one embodiment. The processing of the work support module 103 after the search module 102 retrieves the input work data may also be the same as in the at least one embodiment.

The work support system 1 according to Modification Example 8 can store each of a plurality of parts which receive an instruction in order for the user or another user to use the AI in association with the search setting. The work support system 1 can retrieve the input work data based on the search setting associated with, among the plurality of parts, the part selected by the user or another user who is using the AI. As a result, the work support system 1 can retrieve the input work data based on the search setting corresponding to the part selected by the user or another user, and hence can increase convenience for the user or another user. The work support system 1 can support the work of the user or another user based on the output from the AI corresponding to the user or another user.

### 6-9. Modification Example 9

For example, as described somewhat in Modification Example 4, the AI functions may be usable from a specific place in the work support service. Even for the same AI assistant function, appropriate input work data may differ depending on the place in which the AI assistant function is installed. Thus, in Modification Example 9, a case in which the search setting is stored in accordance with the place in which the AI assistant function is installed is described.

The search setting storage module 101 in Modification Example 9 can store each of a plurality of places in which the AI is used in the work support service in association with the search setting. The place in which the AI is used is the same as the place described in Modification Example 4. In the example of FIG. 13, the place in which the AI assistant function is installed corresponds to the place in which the AI is used. The meaning of "place" is as described in Modification Example 4. In Modification Example 9, an app is described as the place in which the AI is used. The user designates a plurality of places in which the AI is used from the setting screen SC4.

For example, there may be a case in which the user designates two places, such as the inquiry handling app and the FAQ app, designates as the search setting of the inquiry handling app that the data source is the inquiry handling app, and designates as the search setting of the FAQ app that the data source is the FAQ app. In this case, the user terminal 30 transmits to the work support server 10 the search setting of the inquiry handling app indicating that the data source is the inquiry handling app and the search setting of the FAQ app indicating that the data source is the FAQ app.

For example, when the user designates other places, the user similarly designates the search setting of each of the plurality of places. The user terminal 30 transmits the place identification information on each of the plurality of places and the search setting designated for that place to the work support server 10. The search setting storage module 101 stores a combination of the place identification information and the search setting received by the work support server 10 in the search setting database DB1. When the user designates two places, such as the inquiry handling app and the FAQ app, the search setting storage module 101 stores the search setting in the search setting database DB1 in association with the place identification information indicating the inquiry handling app. The search setting storage module 101 stores the search setting in the search setting database DB1 in association with the place identification information indicating the FAQ app.

The search module 102 in Modification Example 9 can retrieve the input work data based on the search setting associated with, among the plurality of places, the place in which the user or another user uses the AI. The search module 102 acquires, from the search setting database DB1, the search setting associated with the place selected by the user or another user who is using the AI among the search settings associated with the place identification information on each of the plurality of places. Modification Example 9 differs from the at least one embodiment in the point that, among the search settings associated with the place identification information on each of the plurality of places, the required search setting is used for the search, but the flow in which the search module 102 executes the search based on the search setting may be the same as in the at least one embodiment. The processing of the work support module 103 after the search module 102 retrieves the input work data may also be the same as in the at least one embodiment.

The work support system 1 according to Modification Example 9 can store each of a plurality of places in which the AI is used in the work support service in association with the search setting. The work support system 1 can retrieve the input work data based on the search setting associated with, among the plurality of places, the place in which the user or another user is using the AI. As a result, the work support system 1 can retrieve the input work data based on the search setting corresponding to the place in which the user or another user is using the AI, and hence can increase convenience for the user or another user. The work support system 1 can support the work of the user or another user based on the output from the AI corresponding to the user or another user.

### 6-10. Modification Example 10

For example, as described somewhat in the at least one embodiment, the user may be able to designate a system prompt from the setting screen SC4. The system prompt is not used in a RAG search, but is input to the AI together with the input work data. In the at least one embodiment, a system prompt is shown in FIG. 8 as well, but the system prompt of FIG. 8 is a prompt designated by the operator of the work support service. In Modification Example 10, the user (a customer from the perspective of the operator) who uses the work support service designates the system prompt.

The search setting storage module 101 in Modification Example 10 stores a system prompt input by the user in association with the search setting. In the example of the setting screen SC4 of the lower half of FIG. 3 and the upper half of FIG. 4, the user inputs a freely-selected piece of text into an input form of the system prompt. For example, the user describes in a natural language the task to be executed by the AI assistant function during the designation of the search setting. When the user designates the system prompt and the search setting on the setting screen SC4, the user terminal 30 transmits the search setting and the system prompt to the work support server 10. The search setting storage module 101 stores the search setting and the system prompt received by the work support server 10 in the search setting database DB1. The system prompt designated by the user may be included in the search setting.

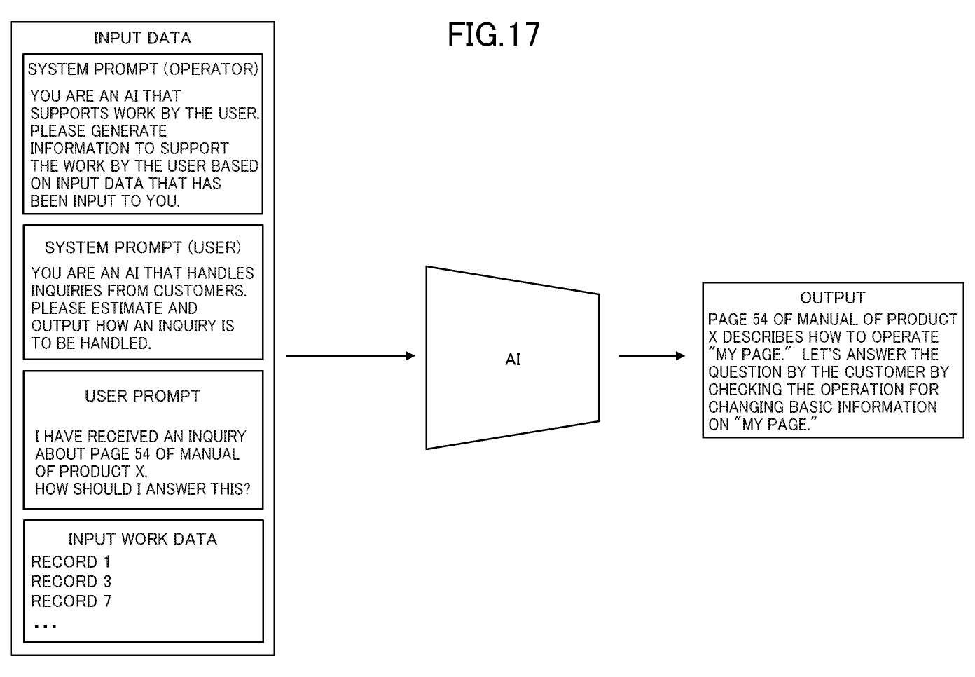

FIG. 17 is a diagram for illustrating an example of AI inputs and an AI output in Modification Example 10. The work support module 103 in Modification Example 10 supports work based on the output from the AI to which the input work data and the system prompt are input. As illustrated in FIG. 17, the work support module 103 inputs, to the AI, input data which includes the system prompt designated by the user in addition to the inputs of FIG. 8 described in the at least one embodiment. The content included in the input data differs from that in the at least one embodiment, but the processing of the AI after the input data is input is the same as in the at least one embodiment. The flow of supporting work by the work support module 103 providing the output from the AI to the user is also the same as in the at least one embodiment.

The work support system 1 according to Modification Example 10 stores a system prompt input by the user in association with the search setting. The work support system 1 supports the work based on the output from the AI to which the input work data and the system prompt are input. As a result, the work support system 1 can support work based on an appropriate output corresponding to the system prompt input by the user, and hence can further increase the accuracy of the output from the AI.

### 6-11. Other Modification Examples

For example, two or more of Modification Examples 1 to 10 may be combined.

For example, the functions described as being implemented by the work support server 10 may be implemented by the user terminal 30. In this case, it suffices that the functions are implemented by a browser script or an application installed on the user terminal 30. For example, the respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, comprising at least one processor configured to:
store a search setting, which relates to a search using retrieval-augmented generation (RAG), and is designated by a user who uses a work support service that supports work;
retrieve, based on the search setting, from a work database that stores work data relating to the work, input work data which is the work data to be input to an artificial intelligence (AI) that supports the work; and
support the work based on an output from the AI to which the input work data is input.

2. The work support system according to claim 1, wherein the at least one processor is configured to:
store a plurality of the search settings; and
retrieve the input work data based on, among the plurality of the search settings, the search setting selected by one of the user or another user who is using the AI.

3. The work support system according to claim 1, wherein the at least one processor is configured to:
store, as the search setting, a search field setting relating to a field which relates to the work database and which is to be searched in the RAG; and
retrieve the input work data based on the search field setting.

4. The work support system according to claim 1, wherein the at least one processor is configured to:
store, as the search setting, a search content setting relating to content which relates to the work data and which is to be retrieved in the RAG; and
retrieve the input work data based on the search content setting.

5. The work support system according to claim 1, wherein the at least one processor is configured to:
store the search setting so that one of the work database of a place other than a specific place in the work support service or the work database of a service other than the work support service is searched; and
search the one of the work database of the place other than the specific place in the work support service or the work database of the service other than the work support service.

6. The work support system according to claim 1, wherein the at least one processor is configured to:
acquire a user prompt input by one of the user or another user who is using the AI;
acquire a keyword for retrieving the input work data based on the user prompt; and
retrieve the input work data based on the search setting and the keyword.

7. The work support system according to claim 1, wherein the at least one processor is configured to:
store the search setting corresponding to one of the user or another user who is using the AI; and
retrieve the input work data based on the search setting corresponding to the one of the user or another user who is using the AI.

8. The work support system according to claim 1, wherein the at least one processor is configured to:
acquire an access right setting relating to an access right of the work database; and
retrieve the input work data based on the search setting and the access right setting.

9. The work support system according to claim 1, wherein the at least one processor is configured to:
store each of a plurality of parts for receiving an instruction in order for one of the user or another user to use the AI in association with the search setting; and
retrieve the input work data based on the search setting associated with, among the plurality of parts, a part selected by the one of the user or another user who is using the AI.

10. The work support system according to claim 1, wherein the at least one processor is configured to:
store each of a plurality of places in which the AI is used in the work support service in association with the search setting; and
retrieve the input work data based on the search setting associated with, among the plurality of places, a place in which one of the user or another user is using the AI.

11. The work support system according to claim 1, wherein the at least one processor is configured to:
store a system prompt input by the user in association with the search setting; and
support the work based on the output from the AI to which the input work data and the system prompt are input.

12. A work support method, comprising:
storing a search setting, which relates to a search using retrieval-augmented generation (RAG), and is designated by a user who uses a work support service that supports work;
retrieving, based on the search setting, from a work database that stores work data relating to the work, input work data which is the work data to be input to an artificial intelligence (AI) that supports the work; and
supporting the work based on an output from the AI to which the input work data is input.

13. A non-transitory information storage medium having stored thereon a program for causing a computer to:
store a search setting, which relates to a search using retrieval-augmented generation (RAG), and is designated by a user who uses a work support service that supports work;
retrieve, based on the search setting, from a work database that stores work data relating to the work, input work data which is the work data to be input to an artificial intelligence (AI) that supports the work; and
support the work based on an output from the AI to which the input work data is input.
